(19) United States
(12) Patent Application Publication
(10) Pub. No.: US 2007/0211706 A1
(43) Pub. Date: Sep. 13, 2007

(54) Communication exchange method between a public switched telephone network and an internet telephone network

(75) Inventor: Hsi Huang, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/651,001

(22) Filed: Jan. 9, 2007

(30) Foreign Application Priority Data
Mar. 10, 2006 (TW) 95108255

(51) Int. Cl. H04L 12/66

(52) U.S. Cl. 370/356

(57) ABSTRACT

A communication exchange method between a public switched telephone network and an internet telephone network comprises steps of: connecting a network telephone server according to a talk request from the caller; obtaining data of at least a connector from the network telephone server; determining if a talk instruction from the caller is received, in which the talk instruction includes the assignment of a callee by the caller; in the case that the talk instruction is received, searching an internet according to the data of the callee, and determining if a qualified callee is located in the internet; and then, in the case that the callee responds to the talk instruction, establishing a talk between the caller and the callee.

### BACKGROUND OF THE INVENTION

(1) Field of the Invention

The invention relates to a communication exchange method, and more particularly to a communication exchange method between a public switched telephone network and an internet telephone network.

(2) Description of the Prior Art

As prosperity of the internet industry, internet network telephone, such as voice over internet protocol (VoIP), voice over (IP) the internet, internet protocol telephony, iphone, or webphone becomes popular. For those who always work with the computers or talk with foreign or remote users over the internet telephone network, it has advantages of convenience and cost-down over the conventional public switched telephone network.

Currently, the internet calling protocol Skype is the most popular in network phoning. Any two remote parties having loaded the Skype can easily and directly talk over the network. Generally, the voice quality of the Skype is compared to that of the conventional cable/mobile phone (i.e. the phone using a public switched telephone network). Also, the Skype has merits in excellent voicing, real-time transmission, overdriving most of firewalls, no interception, and simultaneous multiple-party talking. Further, the Skype can be used to forward word messages and photos and to communicate with others through a much friendly name list.

However, the network phoning can only be practiced between users having the same network communication protocol. As long as one is away from the computer having the network telephone, he/she can only talk with the others through the cable phones or the mobile phones.

Though some switch facilities have been developed to make possible the talk between a network-telephone user and a cable/mobile-phone user, yet the requirements that the callee name list needs to be set in advance limits the convenience of such calling type.

### SUMMARY OF THE INVENTION

Accordingly, it is an object of the present invention to provide a communication exchange method between a public switched telephone network and an internet telephone network. The communication exchange method applicable to a caller of the public switched telephone network comprises steps of: connecting a network telephone server according to a talk request from the caller; obtaining data of at least a connector from the network telephone server; determining if a talk instruction from the caller is received, in which the assignment of a callee by the caller is comprised; in the case that the talk instruction is received, searching an internet according to a data of the callee in the assignment, and determining if a qualified callee is located in the internet; and then, in the case that the callee responds to the talk instruction, establishing a talk between the caller and the callee.

In the present invention, the communication exchange method applicable to a caller of the internet telephone network comprises steps of: the public switched telephone network receiving a talk request; searching for a qualified callee in a built-in database according to the talk request; determining if a qualified callee is located in the built-in database; and, in the case that the qualified callee is located, issuing a communication instruction to the qualified callee through the public switched telephone network.

All these objects are achieved by the communication exchange method between a public switched telephone network and an internet telephone network described below.

### BRIEF DESCRIPTION OF THE DRAWINGS

The present invention will now be specified with reference to its preferred embodiment illustrated in the drawings, in which:

FIG. 1 is a flowchart of a preferred embodiment of the communication exchange method between a public switched telephone network and an internet telephone network in accordance with the present invention; and

FIG. 2 is a flowchart of another preferred embodiment of the communication exchange method between a public switched telephone network and an internet telephone network in accordance with the present invention.

### DESCRIPTION OF THE PREFERRED EMBODIMENT

The invention disclosed herein is directed to a communication exchange method between a public switched telephone network and an internet telephone network. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

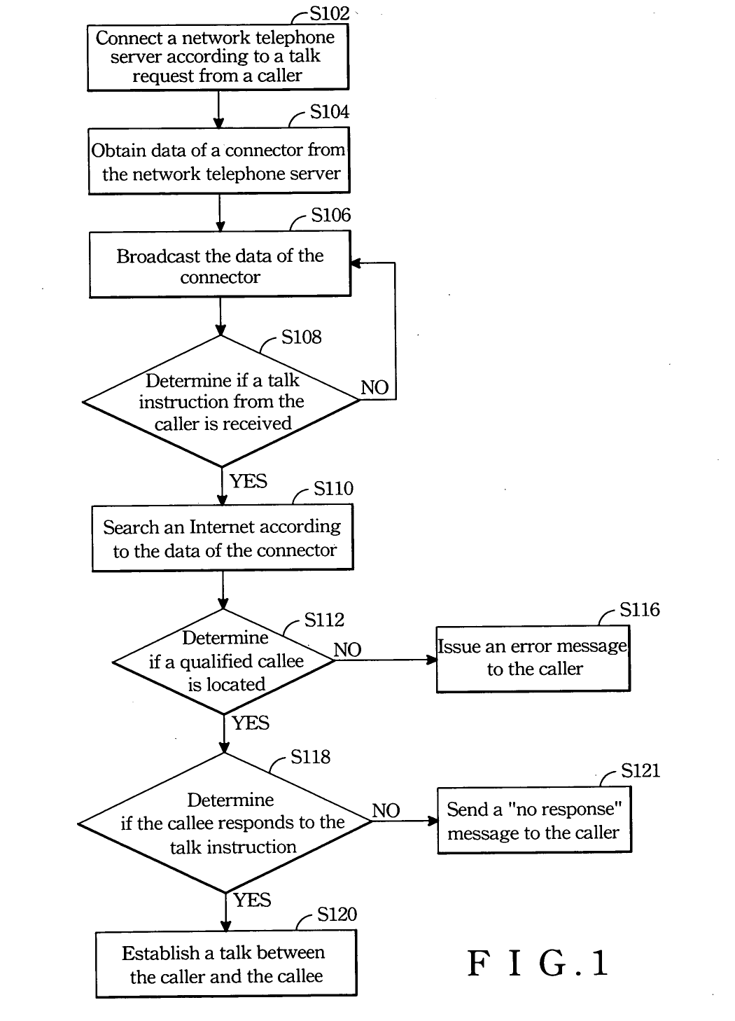

Referring now to FIG. 1, a flowchart of a preferred embodiment of the communication exchange method between a public switched telephone network and an internet telephone network in accordance with the present invention is shown. The public switched telephone network (PSTN) can be a cable phone system or a mobile phone system, while the internet telephone network can be an internet network using the Skype protocol.

In this embodiment, the communication exchange method is applicable to a situation that a caller of the PSTN issues a talk request through the PSTN to a network. The talk request is directly forwarded to an assigned network telephone server (S102). In the present invention, the network that is able to provide the network telephone service may be various, yet the assigned network telephone server can be determined in advance by the caller or the PSTN.

Then, according to the talk request from the caller, the network telephone server searches a database containing various connector data preset by the caller, and obtains proper data of at least a connector. The connector data is forwarded to the PSTN through the network (S104).

In the present invention, the connector data can be a network phone account, a nickname or any the like of the callee.

As soon as the PSTN receives the connector data and shows the data in a screen or through a broadcasting device, the caller can determine the target callee (S106).

In the present invention, as the connector data is showing, the caller can press a hot button (a preset button) at the phone set of the PSTN to issue a talk instruction. Preferably, when the PSTN shows the connector data, the PSTN can still detect if another talk instruction is coming (S108).

As soon as the PSTN receives the talk instruction, a search in the network according to the data of the callee begins. The search can be a determination through the network telephone server whether the callee is on line, or a search of the website through the internet (S110). On the other hand, if the PSTN does not receive the talk instruction, the connector data is kept displaying or broadcasting.

Then, determine if a qualified callee is located in the internet (S112). If the qualified callee is located, send a talk message to the callee (S114). If no qualified callee is located, send an error message to the caller (S116).

In the present invention, the error message can be a message showing that the callee is not on line, a message of wrong accounts, or any the like.

As, for example, the network telephone server forwards the talk message to the callee, the network telephone server can also judge at the same time if the callee responds to the talk message (S118). If the callee responds, the network telephone server can then establish a talk between the caller and the callee (S120). On the other hand, if no response from the callee is received within a predetermined time duration, the network telephone server can issue a no-response message to the caller (S121).

In the present invention, the no-response message can be a message showing that the callee refuses to respond, a message of line busy, a message of callee unavailable, or any the like.

In the foregoing description, the caller is a PSTN user while the callee is a user of the internet telephone network.

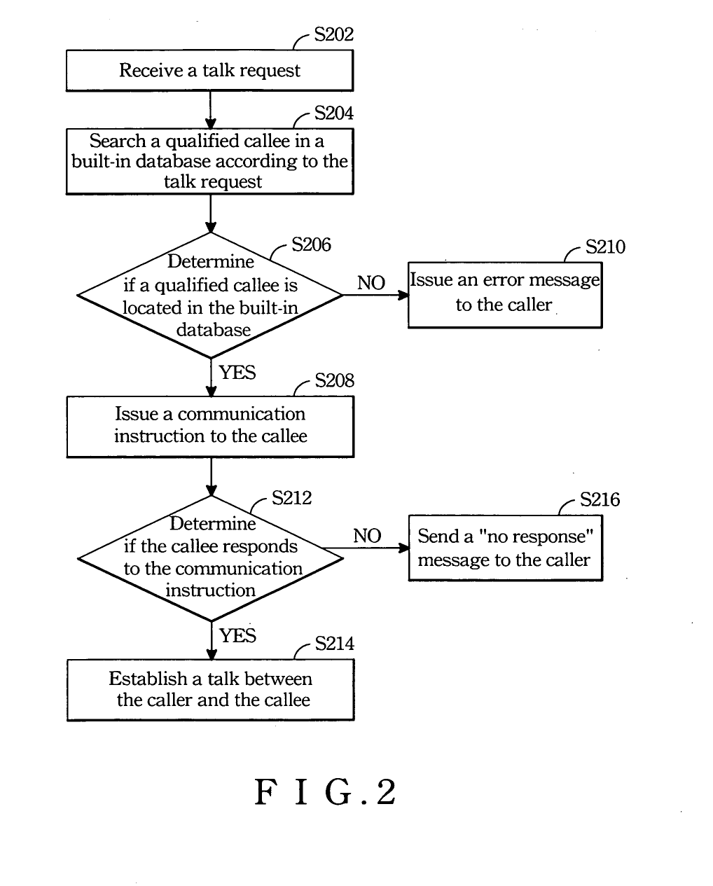

Referring now to FIG. 2, a flowchart of another preferred embodiment of the communication exchange method between a public switched telephone network and an internet telephone network in accordance with the present invention is shown. This embodiment is applicable to a situation that a caller issues the talk request in the internet telephone network.

In this embodiment, the caller uses a network telephone to issue a talk request to the PSTN (S202).

Preferably, the talk request can be a cable/mobile phone number of the callee.

Then, a server of the PSTN searches for a qualified callee in a built-in database according to the talk request (S204). In the present invention, the database can be a phonebook.

The server of the PSTN determines if a qualified callee is located in the built-in database (S206). If positive, the PSTN can issue a communication/talk instruction to the callee. If negative, the PSTN or the server of the PSTN can issue an error message to the caller through the internet or the server of the internet telephone network (S210).

In the present invention, the error message can be a message of wrong number, or a message of line busy.

In step 212, the server of the PSTN determines if the callee responds to the communication instruction. If positive, the server of the PSTN can use the PSTN, the internet or the network telephone to establish a talk between the caller and the callee (S214).

On the other hand, if the callee does not respond to the communication instruction, the server of the PSTN can issue a “no response” message to the caller through the PSTN, the internet or the network telephone (S216)

In the present invention, the “no-response” message can be a message showing that the callee refuses to respond, a message of line busy, a message of callee unavailable, or any the like.

By providing the communication exchange method between the PSTN and the internet telephone network in accordance with the present invention, the user of the PSTN can arbitrarily make his/her call to a network user, and the user of the internet telephone network can also freely make his/her call to a user of the PSTN.

While the present invention has been particularly shown and described with reference to a preferred embodiment, it will be understood by those skilled in the art that various changes in form and detail may be without departing from the spirit and scope of the present invention.

I claim:

1. A communication exchange method between a public switched telephone network (PSTN) and an internet telephone network, comprising the steps of:
a caller of the PSTN issuing a talk request;
the PSTN connecting a server of the internet telephone network according to the talk request;
the PSTN obtaining a data of at least a connector from the server;
the PSTN determining if a talk instruction which comprises an assignment of a callee from the caller is received;
the PSTN searching the internet telephone network according to a data of the callee in the assignment if the talk instruction is received;
the PSTN determining if the callee is located; and
the PSTN establishing a talk between the caller and the callee if the callee is located.

2. The communication exchange method between a public switched telephone network and an internet telephone network according to claim 1, further comprising a step of said PSTN displaying said data of at least said connector to said caller.

3. The communication exchange method between a public switched telephone network and an internet telephone network according to claim 2, further comprising a step of said PSTN keeping displaying said data of at least said connector to said caller till said talk instruction is received.

4. The communication exchange method between a public switched telephone network and an internet telephone network according to claim 2, wherein said data of said connector is displayed in a screen.

5. The communication exchange method between a public switched telephone network and an internet telephone network according to claim 1, further comprising a step of said PSTN broadcasting said data of at least said connector to said caller.

6. The communication exchange method between a public switched telephone network and an internet telephone network according to claim 5, further comprising a step of said PSTN keeping broadcasting said data of at least said connector to said caller till said talk instruction is received.

7. The communication exchange method between a public switched telephone network and an internet telephone network according to claim 1, further comprising a step of said PSTN issuing an error message to said caller if no said callee is located.

8. The communication exchange method between a public switched telephone network and an internet telephone network according to claim 1, wherein said “the PSTN establishing a talk between the caller and the callee” further comprises the steps of:
said PSTN issuing a talk message to said callee;
said PSTN determining if said callee responds to the talk message;
said PSTN establishing said talk between said caller and said callee if said callee responds to the talk message; and
said PSTN issuing a “no response” message to said caller if said callee does not respond to the talk message.

9. The communication exchange method between a public switched telephone network and an internet telephone network according to claim 1, wherein said data of said connector includes an account of said callee in said internet telephone network.

10. The communication exchange method between a public switched telephone network and an internet telephone network according to claim 1, wherein said data of said connector includes a nickname of said callee in said internet telephone network.

11. The communication exchange method between a public switched telephone network and an internet telephone network according to claim 1, wherein said “the PSTN connecting a server of the internet telephone network according to the talk request” is performed by said PSTN forwarding said talk request to said server of said internet telephone network through said internet.

12. A communication exchange method between a public switched telephone network (PSTN) and an internet telephone network, comprising the steps of:
a caller of the internet telephone network issuing a talk request;
the PSTN receiving the talk request;
the PSTN searching for a callee in a built-in database of the PSTN according to the talk request;
the PSTN determining if a qualified callee is located in the built-in database; and
the PSTN issuing a communication instruction to the qualified callee if the qualified callee is located in the built-in database.

13. The communication exchange method between a public switched telephone network and an internet telephone network according to claim 12, further comprising steps of:
said PSTN determining if said qualified callee responds to said communication instruction;
a talk being established between said caller and said qualified callee if said qualified callee responds to said communication instruction; and
a “no response” message is forwarded to said caller if said qualified callee does not respond to said communication instruction.

14. The communication exchange method between a public switched telephone network and an internet telephone network according to claim 12, further comprising a step of sending an error message to said caller if said qualified callee is not located in said built-in database.

15. The communication exchange method between a public switched telephone network and an internet telephone network according to claim 12, wherein said talk request is a telephone number of said callee.

16. A communication exchange method between a public switched telephone network (PSTN) and an internet telephone network, comprising the steps of:
when a caller of the PSTN issuing a talk request,
the PSTN connecting a server of the internet telephone network according to the talk request;
the PSTN obtaining a data of at least a connector from the server;
the PSTN determining if a talk instruction which comprises an assignment of a callee from the caller is received;
the PSTN searching the internet telephone network according to a data of the callee in the assignment if the talk instruction is received;
the PSTN determining if the callee is located; and
the PSTN establishing a talk between the caller and the callee if the callee is located; and
when a caller of the internet telephone network issuing a talk request,
the PSTN receiving the talk request;
the PSTN searching for a callee in a built-in database of the PSTN according to the talk request;
the PSTN determining if a qualified callee is located in the built-in database; and
in the case that the qualified callee is located in the built-in database, the PSTN issuing a communication instruction to the qualified callee if the qualified callee is located in the built-in database.
